(19) United States
(12) Patent Application Publication
(10) Pub. No.: US 2010/0332081 A1
(43) Pub. Date: Dec. 30, 2010

(54) Method for activating a superimposed steering system

(75) Inventors: Hendrik Buering, Schwaebisch Gmuend (DE); Reinhard Grossheim, Abtsgmuend (DE); Thomas Wanner, Schwaebisch Gmuend (DE)

Correspondence Address: JORDAN AND HAMBURG LLP, 122 EAST 42ND STREET, SUITE 4000, NEW YORK, NY, 10168, US

(73) Assignee: ZF Lenksysteme GmbH, Schwaebisch Gmuend (DE)

(21) Appl. No.: 12/799,883

(22) Filed: May 4, 2010

Related U.S. Application Data
(63) Continuation of application No. PCT/EP2008/059344, filed on Jul. 17, 2008.

(30) Foreign Application Priority Data
Nov. 6, 2007 (DE) 10 2007 000 976.5

(51) Int. Cl. B62D 6/00

(52) U.S. Cl. 701/42; 180/400

(57) ABSTRACT

Disclosed is a method for actuating a superimposed steering system, a superimposed steering system, a controller, a computer program, and a computer program product. In the method, a steering ratio is produced as a function of the driving speed, with the magnitude of a time delay being adjusted as a function of the driving speed.

### REFERENCE TO RELATED APPLICATION

This is a continuation application of PCT/EP2008/059344, filed Jul. 17, 2008. The subject matter of the aforementioned prior applications is hereby incorporated herein by reference.

### BACKGROUND OF THE INVENTION

The invention relates to a method for operating a superimposed steering system, to such a superimposed steering system, to a controller for use in such a superimposed steering system, and to a computer program and a computer program product having program code means for carrying out such a method.

In a superimposed, or angular superimposed steering system, the steering wheel angle specified by the driver is superimposed with a superimposition angle, or additional angle, in order to provide situation-dependent support for the driver. This produces what is referred to as the pinion angle, which determines the actual steering angle, and thus the degree of excursion of the coupled wheels.

The speed-dependent variable transmission ratio in superimposed steering systems functions so as to determine a speed-dependent variable steering ratio, between the steering wheel angle and the pinion angle, as a function of the longitudinal vehicle speed. This relationship produces a superimposition angle, or additional angle, which is implemented by an additional angle actuator in the superimposed steering system.

In known methods for operating a superimposed steering system, a steering wheel angle, which is specified by a steering handle is converted by a steering transmission into a pinion angle, which determines the magnitude of the wheel steering angle for at least one steerable wheel of the motor vehicle. In the process, an additional angle is generated and superimposed on the specified steering wheel angle in the steering transmission. Thus the steering wheel angle, which is determined by the driver, is superimposed with an additional angle, which is usually generated as a function of the driving speed.

The steering angle δ_{S}, which is specified by way of the steering wheel, is superimposed with the additional angle δ_{M}, so as to produce a pinion angle δ_{G}, which directly influences the steering angle δ_{F} at the front wheels.

The following applies:

$${i}_{v} = \frac{{δ}_{S}}{{δ}_{F}}$$

where iᵥ denotes the transmission ratio which defines the ratio between the steering wheel angle δ_{S} and the front wheel angle δ_{F}.

The steering ratio of the superimposed steering system, which determines the ratio between the steering wheel angle δ_{S} and the pinion angle δ_{G}, therefore directly influences the transmission ratio iᵥ.

During so-called active steering maneuvers, the steering ratio is varied as a function of the driving speed, and usually of the wheel angle. At higher speeds, such as on a highway off-ramp, the speed should affect the steering ratio more slowly. The speed signal passes through a signal filter for this purpose. If the vehicle decelerates quickly with the steering wheel turned, the time delay produced by the signal filter may result in a movement of the steering wheel after the vehicle has come to a stop. This movement is undesired.

The object is therefore to avoid this disadvantageous effect.

### SUMMARY OF THE INVENTION

In the method according to the invention for actuating a superimposed steering system, in which a steering ratio is varied as a function of the driving speed, with the driving speed being taken into consideration in a time delayed manner, in determining the steering ratio, the time delay is varied as a function of the driving speed.

Changing the time delay, or varying the magnitude of the time delay, allows the driving speed to be included in the calculation of the steering ratio, and therefore in the motor target angle, as quickly as possible, particularly in situations in which the vehicle decelerates quickly, so that no movement is generated in the steering wheel when the vehicle has come to a stop.

The time delay can be adjusted by way of at least one filter. If, for example, two filters are used, which are typically PT1 filters, the filter having the shorter time delay will be used at driving speeds below a predetermined value. In principle, it is possible to use a plurality of filters, which are each associated with a particular speed range.

As an alternative, it is also possible to use an adaptive filter, the time constant of which can be varied as a function of the driving speed.

Accordingly, this adaptive filter has a variable filter constant, which is to say that, at low speeds, the signal carrying the driving speed information is delayed to a lesser degree than at high speeds. In this manner, if the vehicle is significantly decelerated, adapting the steering ratio can be completed in advance, while the vehicle is slowing down. Thus, when the vehicle has come to a stop, the steering wheel will not move.

The steering ratio is further designed so as to be varied as a function of a wheel angle.

The superimposed steering system for a motor vehicle according to the invention comprises: a steering handle for specifying a steering wheel angle as a magnitude of a desired steering angle for at least one steerable wheel of the motor vehicle; an additional angle actuator, which generates an additional angle or superimposition angle, as a function of the driving speed; and a steering transmission, which converts the steering wheel angle into a pinion angle, by superimposing the additional angle on the steering wheel angle. In this process, the driving speed is taken into consideration in a time delayed manner, with the time delay, or the magnitude thereof, being varied as a function of the driving speed.

In the superimposed steering system, the additional angle actuator is configured comprising an electric motor, which is actuated by a controller.

The controller according to the invention is used, in particular, for carrying out the method described above, and is employed in a superimposed steering system as described above. This controller is designed to determine an additional angle as a function of the driving speed, wherein the driving speed is taken into consideration in a time delayed manner. The time delay is varied as a function of the driving speed.

The computer program according to the invention comprises program code means for carrying out a method of operating a superimposed steering system of the type described above, in the case that the computer program is executed by a microprocessor of a computer, and in particular in a controller of the superimposed steering system.

This computer program can be stored on a computer-readable data medium, such as a diskette, CD, DVD, hard drive, USB memory stick or the like, or on an Internet server, as a computer program product. From there, the computer program can be transferred into a storage element of the controller.

Further advantages and embodiments of the invention will be apparent from the description and the accompanying drawings.

It is a matter of course that the abovementioned characteristics and those described below can be used, not only in the described combination, but also in other combinations or independently, without departing from the scope of the present invention.

The invention is schematically illustrated in the drawings based on an exemplary embodiment, and will be described in detail hereinafter with reference to the drawings.

### BRIEF DESCRIPTION OF THE DRAWINGS

FIG. 1 shows an embodiment of the superimposed steering system according to the invention.

FIG. 2 shows an exemplary transmission ratio, as a function of vehicle speed, serving to illustrate the method according to the invention.

### DESCRIPTION OF THE PREFERRED EMBODIMENTS

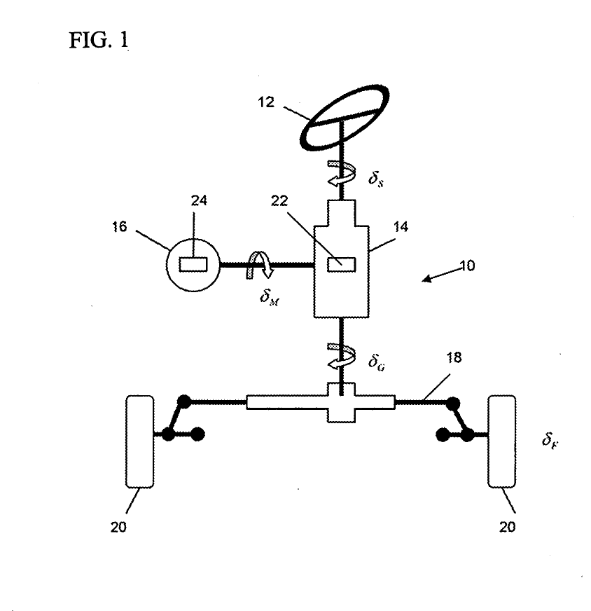

FIG. 1 illustrates an embodiment of the superimposed steering system according to the invention, indicated in its entirety by reference numeral 10. The illustration shows: a steering handle 12, which in this case is a steering wheel; a steering transmission 14; an additional angle actuator 16; and two front wheels 20, which are connected by way of a front axle 18 and coupled so as to allow the vehicle to be controlled.

Furthermore, a controller 22 is provided for actuating an electric motor 24 of the additional angle actuator 16.

In the steering transmission 14, the steering angle δ_{S} specified by way of the steering handle 12 is superimposed with an additional angle, or motor steering angle δ_{M}, which is the superimposed additional angle of the electric motor 24, of the additional angle actuator 16, resulting in a pinion angle δ_{G} which directly influences the steering angles δ_{F} at the front wheels.

The following applies

$${i}_{v} = \frac{{δ}_{S}}{{δ}_{F}}$$

and

δ_{M}×i_{M}+δ_{S}×i_{D}=δ_{G}

where i_{M} and i_{D} are factors to be specified.

The driving speed of the motor vehicle is taken into consideration in the determination of the additional angle δ_{M}, in a time delayed manner. According to the invention, the time delay is varied as a function of the driving speed, which is to say that, the magnitude of the time delay is varied as a function of the driving speed. In this manner, the speed can be included the calculation of the additional angle δ_{M} as quickly as possible, in situations in which the vehicle decelerates quickly with the steering wheel turned, so as not to generate a movement of the steering wheel when the vehicle has come to a stop.

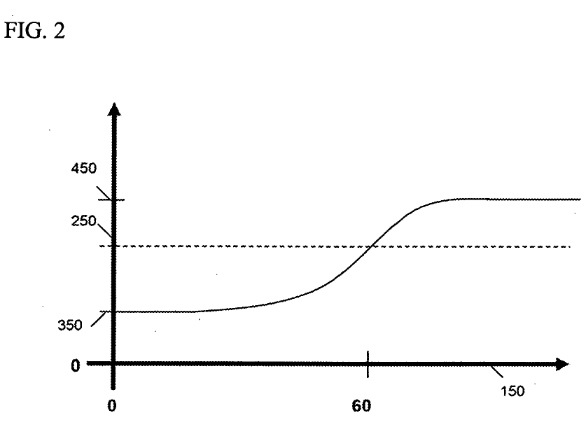

FIG. 2 shows a graph of an exemplary transmission ratio as a function of the driving speed, serving to illustrate the method according to the invention.

In the graph shown, the vehicle speed is plotted on the abscissa 150 and the transmission ratio iᵥ is plotted on the ordinate 250. The graph thus illustrates the transmission ratio iᵥ as a function of the vehicle speed, with the transmission ratio iᵥ being defined as the ratio between the steering wheel angle and the front wheel angle, which is to say:

iᵥ=target ratio=steering wheel angle/front wheel angle

The transmission ratio iᵥ ranges between i_{v min} 350 at low speeds, which is to say in direct operation or in direct gear, and i_{v max} 450 at high speeds, which is to say in indirect operation. It is apparent that steering is performed in a purely mechanical manner at a speed of 60 km/h, and the additional angle actuator does not intervene. At low speeds, supporting intervention takes place, and at high speeds, countersteering is performed.

Here, it must be remembered that the speed of the vehicle is included in a time delayed manner, which is, for example, produced by a filter on the path of the signal that carries the information concerning the vehicle speed. According to the invention, this time delay is established as a function of the vehicle speed.

This means that, when driving at low speeds, the vehicle speed will affect the determination of the additional angle more quickly than when driving high speeds. Thus, the steering wheel will not move when the vehicle has come to a stop.

1. A method for actuating a superimposed steering system in which a steering ratio is varied as a function of the driving speed, comprising taking into consideration the driving speed in a time delayed manner, and varying the time delay as a function of the driving speed.

2. The method according to claim 1, comprising adjusting the time delay by way of at least one filter.

3. The method according to claim 2, comprising utilizing an adaptive filter.

4. A method according to claim 1 comprising additionally varying the steering ratio as a function of a steering wheel angle (δ_{S}).

5. A superimposed steering system for a motor vehicle, comprising a steering handle for specifying a steering wheel angle (δ_{S}), an additional angle actuator which generates an additional angle (δ_{M}) as a function of the driving speed, the driving speed being taken into consideration in a time delayed manner, and a steering transmission which translates the steering wheel angle (δ_{S}) into a pinion angle (δ_{G}) by superimposing the steering wheel angle (δ_{S}) with the additional angle (δ_{M}), wherein the time delay is varied as a function of the vehicle speed.

6. The superimposed steering system according to claim 5, wherein the additional angle actuator comprises an electric motor which is actuated by a controller.

7. A controller used in a steering system comprising means to determine an additional angle (δ_{M}) as a function of the driving speed, said means comprising time delay means for taking into consideration the driving speed in a time delayed manner, and means for varying the time delay as a function of the driving speed.

8. A computer program having program code means for carrying out a method according to claim 1, wherein the computer program is executed on a microprocessor of a computer in a superimposed steering system.

9. A computer program product having program code means stored on a computer-readable data medium for carrying out a method according to claim 1 wherein the computer program is executed on a microprocessor of a computer in a superimposed steering system.

10. A computer program having program code means for carrying out operation of a superimposed steering system according to claim 5 wherein the computer program is executed on a microprocessor of a computer.

11. A computer program having program code means for carrying out operation of a controller according to claim 7 wherein the computer program is executed on a microprocessor of a computer in a superimposed steering system.

12. A computer program product having program code means stored on a computer-readable data medium for carrying out the operation of a superimposed steering system according to claim 5, wherein the computer program is executed on a microprocessor of a computer.

13. A computer program product having program code means stored on a computer-readable data medium for carrying out the operation of a controller of a superimposed steering system according to claim 7, wherein the computer program is executed on a microprocessor of a computer.
